(19) United States
(12) Patent Application Publication
(10) Pub. No.: US 2023/0084545 A1
(43) Pub. Date: Mar. 16, 2023

(54) Inflatable Chair Lifting Device

(71) Applicant: Deidra Harrison, Bear, DE (US)

(72) Inventor: Deidra Harrison, Bear, DE (US)

(21) Appl. No.: 17/943,787

(22) Filed: Sep. 13, 2022

Related U.S. Application Data
(60) Provisional application No. 63/243,296, filed on Sep. 13, 2021.

(51) Int. Cl. A61G 7/10

(52) U.S. Cl. CPC A61G 7/1021

(57) ABSTRACT

The present invention relates to an inflatable chair lifting device comprised of an inflatable body further comprised of a pair of side members, a backrest member, a front member, a seat member, an electric pump and a foot pump. The body is preferably hollow and inflatable and may be generally configured as a chair. The body can be placed under a fallen user in an uninflated state, such that the body can then be fully inflated to form a chair-like structure that raises a user from a fallen position. The body can further be inflated manually via blowing air into the body, via a foot pump or via an integrated electric pump.

### CROSS-REFERENCE TO RELATED APPLICATION

The present application claims priority to, and the benefit of, U.S. Provisional Application No. 63/243,296, which was filed on Sep. 13, 2021 and is incorporated herein by reference in its entirety.

### FIELD OF THE INVENTION

The present invention relates generally to the field of lifting fallen individuals. More specifically, the present invention relates to an inflatable chair lifting device primarily comprised of an inflatable body, further comprised of a pair of side members, a backrest member, a front member, a seat member, an electric pump and a foot pump. The body of the device can be placed under a fallen user in an uninflated state, such that the body can then be fully inflated to form a chair-like structure that raises a user from a fallen position. Accordingly, the present disclosure makes specific reference thereto. Nonetheless, it is to be appreciated that aspects of the present invention are also equally applicable to other like applications, devices and methods of manufacture.

### BACKGROUND

One out of four older adults, approximately 36 million people, fall each year in the United States. This problem is extremely prevalent in elderly adults who have disabilities, bone/joint conditions, arthritis or are extremely overweight. If these individuals suffer a fall, it may be increasingly difficult for a caregiver or other nearby individual to lift the individual who has fallen, based on the fragility or weight of the fallen individual. In addition, a nearby individual may not be physically strong enough to lift a fallen adult on his or her own and may then additionally get injured when attempting to pick up the fallen adult.

Therefore, there exists a long-felt need in the art for a device that allows a single user to aid an individual who has fallen. There also exists a long-felt need in the art for an inflatable chair lifting device that does not require a single user to be physically capable of lifting a fallen individual, to aid the fallen individual in standing. In addition, there exists a long-felt need in the art for an inflatable chair lifting device that prevents a user from becoming injured by attempting to lift a fallen user.

The subject matter disclosed and claimed herein, in one embodiment thereof, comprises an inflatable chair lifting device. The device is primarily comprised of an inflatable body, further comprised of a pair of side members, a backrest member, a front member, a seat member, an electric pump and a foot pump. The body is preferably hollow and inflatable and may be generally shaped like objects, such as but not limited to, a chair, a stool, a bed, etc., or any three-dimensional shape. The body can be placed under a fallen user in an uninflated state, such that the body can then be fully inflated to form a chair-like structure that raises a user from a fallen position. The body can further be inflated manually via blowing air into the body or via a foot pump, or by an integrated electric pump.

In this manner, the inflatable chair lifting device of the present invention accomplishes all of the forgoing objectives and allows a single user to aid a fallen individual in standing, and does not require a single individual to be physically capable of lifting the fallen individual to do so. In addition, the device prevents a user from becoming injured by attempting to lift a fallen user. In this manner, the inflatable chair lifting device overcomes the limitations of existing methods of lifting a fallen individual known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an inflatable chair lifting device. The device is primarily comprised of an inflatable body further comprised of a pair of side members, a backrest member, a front member, a seat member, an electric pump and a foot pump. The body is preferably hollow and inflatable and may be generally shaped like objects, such as but not limited to, a chair, a stool, a bed, etc., or any three-dimensional shape known in the art. The body is further preferably manufactured from any material known in the art, but is preferably made of a plastic that can be inflated. In the preferred embodiment, the body is configured in the general shape of a chair and has a pair of side members that act as armrests, a backrest member that supports the back of a user, a seat member that allows a user to sit on the body, and a front member that a user can rest his or her legs against. The device may also have a one-piece hollow body or a body that has internal sections/compartments.

To allow for easy manual inflation of the device, the body may also be comprised of an inflation valve that allows a user to manually inflate the body by blowing air into the body from the lungs. Additionally or alternatively, the body may be comprised of an integrated electric pump that is integrally formed to the body, such that a user can easily inflate and deflate the body by pressing at least one button located on the pump. The pump is further powered by a battery. The device may also be comprised of a foot pump that provides another means for a user to manually inflate the body. The pump is further comprised of a hollow, collapsible accordion-like body that is fixedly or removably-connected to a hollow tubing, wherein the end of the tubing is further comprised of a hollow protrusion. The protrusion can be inserted into the inflation valve, to allow a user to inflate the body of the device via repeatedly pressing down on the foot pump body. In addition, to allow for easy manual deflation of the device, the body may also be comprised of a release valve that allows a user to manually deflate the body.

The device can further be used in a method to aid a user who has fallen and cannot get up unassisted or cannot be easily lifted by other nearby users. To aid a fallen user in getting up, a second user first places the device, while in an uninflated state, underneath the body of the first user who has fallen and is lying on the ground. Then, a second user inflates the body manually by using the inflation valve and blowing air into the body, inflating the body via the electric pump and/or inflating the body via the foot pump. As the body begins to inflate, the body will begin to form a generally chair-like shape and the first user will be lifted upwards into a sitting position. Once the body has been fully inflated, the first user will be in a sitting position and can then get up from the body, either unassisted or with the assistance of the second user.

Accordingly, the inflatable chair lifting device of the present invention is particularly advantageous as it allows a single user to aid an individual who has fallen. The device further does not require a single user to be physically capable of lifting a fallen individual, to aid the fallen individual in standing. In addition, the device prevents a user from becoming injured by attempting to lift a fallen user. In this manner, the inflatable chair lifting device overcomes the limitations of existing methods of lifting a fallen individual known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the inflatable chair lifting device of the present invention in an uninflated state in accordance with the disclosed architecture;

FIG. 2 illustrates a perspective view of one potential embodiment of the inflatable chair lifting device of the present invention in a partially inflated state in accordance with the disclosed architecture;

FIG. 3 illustrates a perspective view of one potential embodiment of the inflatable chair lifting device of the present invention in a fully inflated state in accordance with the disclosed architecture;

FIG. 4 illustrates a perspective view of one potential embodiment of a foot pump device of the inflatable chair lifting device of the present invention in accordance with the disclosed architecture; and

FIG. 5 illustrates a flow chart of one potential method of using the inflatable chair lifting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that allows a single user to aid a fallen individual. There also exists a long-felt need in the art for an inflatable chair lifting device, that does not require a single user to be physically capable of lifting a fallen individual to aid the fallen individual in standing. In addition, there exists a long-felt need in the art for an inflatable chair lifting device that prevents a user from becoming injured by attempting to lift a fallen individual.

The present invention, in one exemplary embodiment, is comprised of an inflatable chair lifting device primarily comprised of an inflatable body further comprised of a pair of side members, a backrest member, a front member, a seat member, an electric pump and a foot pump. The body is preferably hollow and inflatable, and may be generally configured as a chair, a stool, a bed, etc., or any other suitable three-dimensional shape as is known in the art. The body is also preferably manufactured from any suitable material as is known in the art, but is preferably made of a plastic that can be inflated. In the preferred embodiment, the body is configured in the general shape of a chair and has a pair of side members that act as armrests, a backrest member that supports the back of a user, a seat member that allows a user to sit on the body and a front member that a user can rest his or her legs against. Further, the device may have a one-piece hollow body or a body that has internal sections.

The body may also be comprised of an inflation valve that allows a user to manually inflate the body by blowing air into the body from the lungs. Additionally or alternatively, the body may be comprised of an integrated electric pump, that is integrally formed to the body, such that a user can easily inflate and deflate the body by pressing at least one button located on the pump. The pump is further powered by a battery. In addition, the device may also be comprised of a foot pump, that provides another means for a user to manually inflate the body. The pump is further comprised of a hollow, collapsible, accordion-like body that is fixedly or removably-connected to a hollow tubing, wherein the end of the tubing is further comprised of a hollow protrusion. The protrusion can be inserted into the inflation valve, to allow a user to inflate the body of the device via repeatedly pressing down on the foot pump body. Further, the body may be comprised of a deflation valve, to allow a user to deflate the body.

The device can further be used in a method to aid a user who has fallen and cannot get up unassisted or cannot be easily lifted by other nearby individuals. To aid a fallen user in getting up, a second user first places the device, while in an uninflated state, underneath the body of the first user who has fallen and is lying on the ground. Then, a second user inflates the body manually by using the inflation valve and blowing air into the body, inflating the body via the electric pump and/or inflating the body via the foot pump. As the body begins to inflate, the body will begin to form a generally chair-like shape and the first user will be lifted upwards into a sitting position. Once the body has been fully inflated, the first user will be in a sitting position and can then get up from the body, unassisted or with the assistance of the second user.

Accordingly, the inflatable chair lifting device of the present invention is particularly advantageous as it allows a single user to aid an individual who has fallen. The device further does not require a single user to be physically capable of lifting a fallen individual, to aid the fallen individual in standing. In addition, the device prevents a user from becoming injured by attempting to lift a fallen user. In this manner, the inflatable chair lifting device overcomes the limitations of existing methods of lifting a fallen individual known in the art.

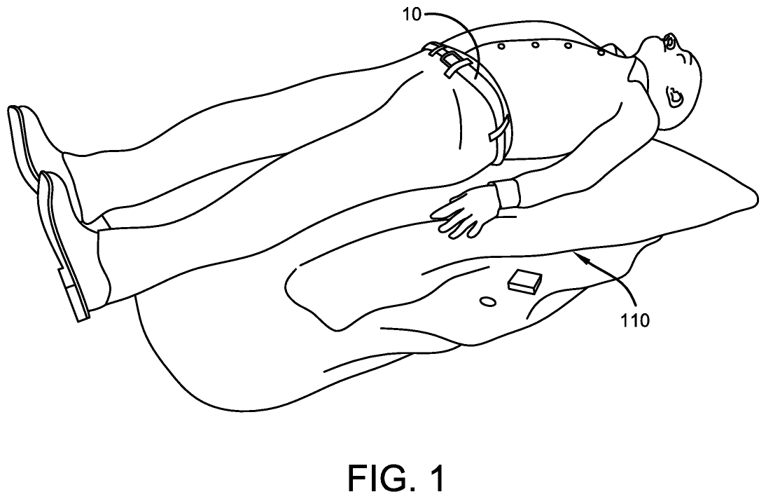

Referring initially to the drawings, FIG. 1 illustrates a perspective view of one embodiment of the inflatable chair lifting device 100 of the present invention in an uninflated state. The device 100 is primarily comprised of an inflatable body 110, further comprised of a pair of side members 112, a backrest member 114, a front member 116, a seat member 118, an electric pump 140 and a foot pump 150. The body 110 is preferably hollow and inflatable. In differing embodiments, the body 110 may be generally configured as a chair, a stool, a bed, etc., or any other suitable three-dimensional shape as is known in the art, such as but not limited to, a circular, an oval, a square, a rectangle, a triangle, a trapezoid, an octagon, a hexagon, etc. The body 110 is preferably manufactured from any suitable material as is known in the art, but is preferably made of a plastic that can be inflated, such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, etc.

In the preferred embodiment, the body 110 is configured in the general shape of a chair. Specifically, the body 110 has a pair of side members 112 that act as armrests, a backrest member 114 that supports the back of a user 10, a seat member 118 that allows a user to sit on the body 110 and a front member 116 that a user 10 can rest his or her legs against. It is further contemplated that any embodiment of the device 100 may have a one-piece hollow body or a body 110 that has internal sections (i.e. compartments) for each member 112, 114, 116, 118 of the body 110. In an embodiment with internal sections, each member 112, 114, 116, 118 of the body 110 is sealed from one another, such that each member 112, 114, 116, 118 can be inflated individually. In this manner, if one member 112, 114, 116, 118 becomes punctured or deflates, the rest of the members 112, 114, 116, 118 will not deflate. To allow for easy manual deflation of the device 100, the body 110 may also be comprised of a release valve 130, that can be opened to allow air to exit the body 110.

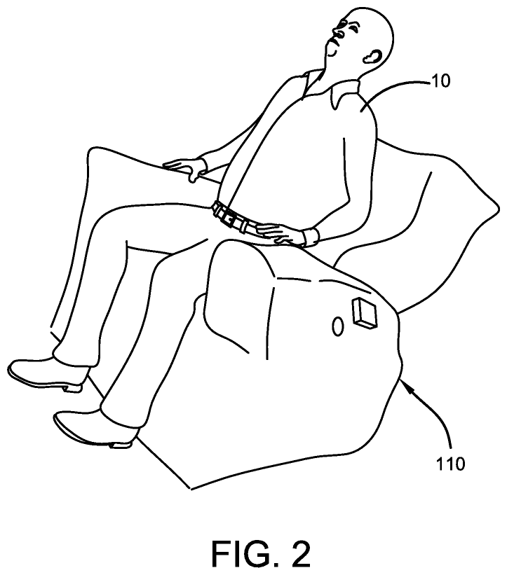

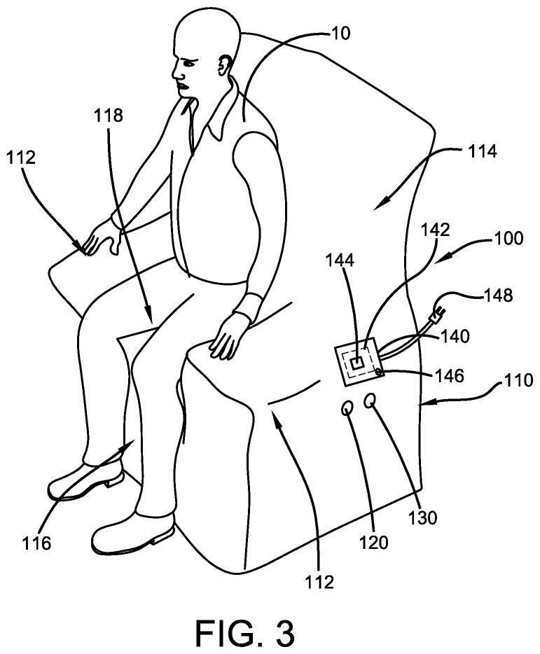

FIGS. 2-3 illustrate a perspective view of one embodiment of the inflatable chair lifting device 100 of the present invention in an inflated state. To fully inflate the body 110 (as seen in FIG. 3), the body 110 is comprised of an inflation valve 120. The inflation valve 120 allows a user 10 to manually inflate the body 110 by blowing air into the body 110 from the lungs. Additionally or alternatively, the body 110 may be comprised of an integrated electric pump 140. The electric pump 140 is integrally formed to the body 110, such that a user can easily inflate and deflate the body 110 by a pressing at least one button 146 located on the pump 140.

The pump 140 is further powered by a battery 142. The battery 142 may be a disposable battery or a rechargeable battery in the form of an alkaline, nickel-cadmium, nickel-metal hydride battery, etc., such as any 3V-12 volts DC battery or other suitable conventional battery as is known in the art, such as A, AA, AAA, etc., that supply power to the device 100. Throughout this specification the term “battery” may be used interchangeably to refer to one or more wet or dry cells or batteries of cells in which chemical energy is converted into electricity and used as a source of DC power. References to recharging or replacing the battery 142 may refer to recharging or replacing individual cells, individual batteries of cells, or a package of multiple battery cells as is appropriate for any given battery technology that may be used. In addition, a rechargeable embodiment of the battery 142 may be recharged using a USB port 144, wherein the USB port 144 is a USB-A, USB-B, Micro-B, Micro-USB, Mini-USB or USB-C port. The battery 142 may also be powered and/or recharged via a power cord 148 that can be plugged into a 120V/240V outlet.

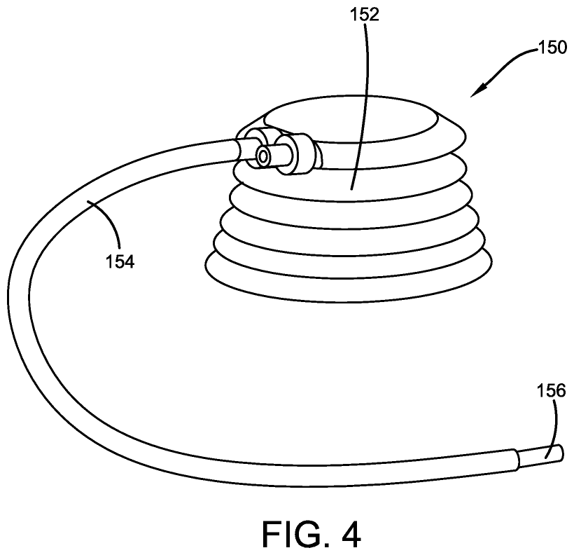

FIG. 4 illustrates a perspective view of one embodiment of a foot pump 150 for the inflatable chair lifting device 100 of the present invention. The device 100 may also be comprised of a foot pump 150 that provides another means for a user to manually inflate the body 110. The pump 150 is further comprised of a hollow, collapsible, accordion-like body 152 that is fixedly or removably-connected to a hollow tubing 154. The end of the tubing 154 is further comprised of a hollow protrusion 156, that can be inserted into the inflation valve 120. As a result, after inserting the protrusion 156 into the valve 120, a user can repeatedly press down on the body 152 by stepping on the body 152 or repeatedly pressing on the body 152 with their hands to inflate the body 110.

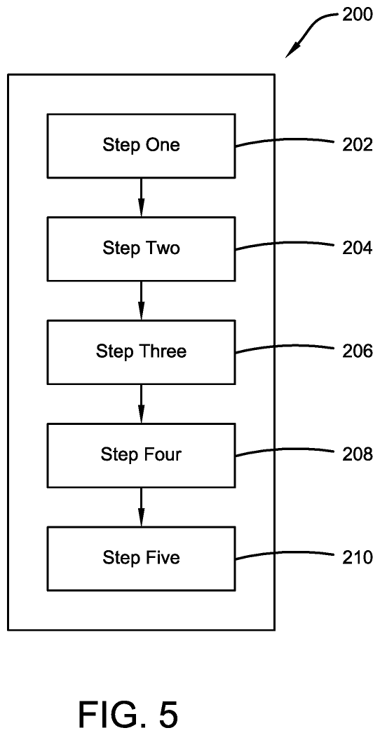

FIG. 5 illustrates a flow chart of one potential method 200 of using the inflatable chair lifting device 100 of the present invention. The device 100 can further be used to aid a user 10 who has fallen and cannot get up unassisted or cannot be easily lifted by other nearby users. To aid a fallen user 10 in getting up, at 202 a second user first places the device 100, while in an uninflated state (as seen in FIG. 1), underneath the body 110 of the first user 10 who has fallen and is lying on the ground. Then at 204, a second user inflates the body 110 manually by using the inflation valve 120 and blowing air into the body 110 or inflating the body 110 via the electric pump 140 and/or inflating the body 110 via the foot pump 150. As the body 110 begins to inflate, at 206 the body 110 will begin to form a generally chair-like shape. As this occurs, at 208 the first user 10 will be lifted upwards into a sitting position. Once the body 110 has been fully inflated (as seen in FIG. 3), at 210 the first user 10 will be in a sitting position and can then get up from the body 110 under his or her own volition or with the assistance of the second user. It should be noted that in one embodiment, the device 100 can also be used solely as an inflatable chair.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “inflatable chair lifting device” and “device” are interchangeable and refer to the inflatable chair lifting device 100 of the present invention.

Notwithstanding the forgoing, the inflatable chair lifting device 100 of the present invention and its various components can be of any suitable size and configuration as is known in the art without affecting the overall concept of the invention, provided that they accomplish the above-stated objectives. One of ordinary skill in the art will appreciate that the size, configuration and material of the inflatable chair lifting device 100 as shown in FIGS. 1-5 is for illustrative purposes only, and that many other sizes and shapes of the inflatable chair lifting device 100 are well within the scope of the present disclosure. Although the dimensions of the inflatable chair lifting device 100 are important design parameters for user convenience, the inflatable chair lifting device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An inflatable chair lifting device that allows a user to aid an individual who has fallen, the inflatable chair lifting device comprising:
a body comprising a pair of side members, a backrest member, a front member, and a seat member;
an inflation valve;
a release valve;
an electric pump; and
a foot pump, wherein the inflatable chair lifting device can lift the individual by inflating the body which is positioned underneath the individual.

2. The inflatable chair lifting device of claim 1, wherein the body is hollow and inflatable.

3. The inflatable chair lifting device of claim 2, wherein the hollow, inflatable body is configured in a shape of a chair, a stool or a bed.

4. The inflatable chair lifting device of claim 1, wherein the pair of side members act as armrests, the backrest member supports a back of the individual, a seat member allows the individual to sit on the body, and the front member supports an individual's legs.

5. The inflatable chair lifting device of claim 1, wherein the body is a one-piece hollow body.

6. The inflatable chair lifting device of claim 1, wherein the body comprises an internal section for each of the side members, the backrest member, the front member and the seat member.

7. The inflatable chair lifting device of claim 1, wherein the electric pump can be used to inflate the body.

8. The inflatable chair lifting device of claim 1, wherein the foot pump can be used to inflate the body.

9. The inflatable chair lifting device of claim 1, wherein the user blows air into the inflation valve to inflate the body.

10. An inflatable chair lifting device that allows a user to aid an individual who has fallen, the inflatable chair lifting device comprising:
a hollow, inflatable body comprising a pair of side members, a backrest member, a front member and a seat member;
an inflation valve in fluid communication with the hollow, inflatable body;
a release valve in fluid communication with the hollow, inflatable body;
an electric pump integrated into the hollow, inflatable body; and
a foot pump in fluid communication with the hollow, inflatable body, wherein the inflatable chair lifting device is positioned on a ground surface beneath the individual.

11. The inflatable chair lifting device of claim 10, wherein the hollow, inflatable body is shaped like a chair when fully inflated.

12. The inflatable chair lifting device of claim 10 further comprising a battery for powering the electric pump.

13. The inflatable chair lifting device of claim 12, wherein the battery is rechargeable via a USB port.

14. The inflatable chair lifting device of claim 12, wherein the battery is rechargeable via a power cord.

15. The inflatable chair lifting device of claim 10, wherein the electric pump is comprised of at least one button that allows the user to inflate or deflate the hollow, inflatable body using the electric pump.

16. The inflatable chair lifting device of claim 10, wherein the foot pump is comprised of a hollow, collapsible, accordion-like body, and a hollow tubing.

17. The inflatable chair lifting device of claim 16, wherein the hollow tubing can be inserted into the inflation valve and the foot pump can be used to inflate the hollow, inflatable body.

18. The inflatable chair lifting device of claim 10, wherein the release valve can be opened to allow air to exit the hollow, inflatable body.

19. The inflatable chair lifting device of claim 10, wherein the user manually blows air into the inflation valve to inflate the hollow, inflatable body.

20. A method of using an inflatable chair lifting device to lift a fallen individual, the method comprising the steps of:
placing the inflatable chair lifting device in an uninflated condition underneath a body of the fallen individual and on a ground surface;
inflating a body of the inflatable chair lifting device by blowing air into the body via an inflation valve or by inflating the body using a foot pump or an electric pump that is integrated into the body;
allowing the body to fully inflate to form a generally chair-like shape which lifts the fallen individual from the ground surface into a sitting position; and
assisting the fallen individual in getting up from the fully inflated body under their own volition or with assistance from another.
